(19) United States
(12) Patent Application Publication
(10) Pub. No.: US 2007/0059669 A1
(43) Pub. Date: Mar. 15, 2007

(54) Systems and methods for processing video images

(75) Inventors: James K. O'Malley, Orlando, FL (US); Gary D. Carlton, Sanford, FL (US); Donna M. Curley, Oviedo, FL (US); Keith Kailing, Heathrow, FL (US)

Correspondence Address: WELSH & KATZ, LTD, 120 S RIVERSIDE PLAZA, 22ND FLOOR, CHICAGO, IL, 60606, US

(73) Assignee: Lockheed Martin Corporation

(21) Appl. No.: 11/501,267

(22) Filed: Aug. 9, 2006

Related U.S. Application Data
(60) Provisional application No. 60/710,555, filed on Aug. 23, 2005.

(51) Int. Cl. G09B 19/16; G09B 9/08

(52) U.S. Cl. 434/38; 434/30

(57) ABSTRACT

A sensor effects processor and tracker system incorporate first and second processors. One processor carries out graphics processing, tracker processing, histogram formation and network communications. The other processor carries out sensor effects processing on a sequence of images received from an image processor. The desired effects can be enabled or disabled by a simulation manager.

### CROSS REFERENCE TO RELATED APPLICATION

This application claims the benefit of the filing date of U.S. Provisional Application Serial No. 60/710,555 filed Aug. 23, 2005 and entitled “Systems and Methods for Processing Video Images”. The '555 application is incorporated herein by reference.

### FIELD OF THE INVENTION

The invention pertains to simulation systems. More particularly, the invention pertains to sensor effects simulation devices and methods.

### BACKGROUND OF THE INVENTION

Some known simulation systems which incorporate frame-based image generators and can be used for training and mission rehearsal in military applications. Such simulators generate synthetic images in real time to present simulated out the window displays, for example an aircraft simulator. Such displays are produced in real time and the greatest degree of fidelity in display of presentation is desired so as to enhance the training and educational experience.

One aspect of such simulations is the incorporation of sensor effects into the displays. For example, it might be desirable to present the images as seen by night vision goggles, infrared sensors or the like depending on the type of equipment being simulated and the nature of the training.

Hardware devices are known which could be coupled between the video outputs of image generation systems and the simulation unit's display devices so as to modify the images being presented to the user with the effects of various sensors. Such units can also provide target tracking capabilities.

While such hardware-based solutions are effective for their intended purposes, it would be desirable to provide software-based real time frame processing so as to take advantage of high speed but relatively inexpensive commercially available digital processors which are manufactured in substantially higher volumes. Preferably such software-based solutions would incorporate a variety of different sensor effects which could be switched in and out of various simulations.

### BRIEF DESCRIPTION OF THE DRAWINGS

FIG. 1 is a block diagram of a system in accordance with the invention;

FIG. 2 illustrates some aspects of processing images in accordance with the invention;

FIG. 3 illustrates additional aspects of processing images in accordance with the invention;

FIGS. 4A-4N taken together illustrate the effects of selecting available sensor effects on a common image;

FIG. 5A illustrates various symbols which can be overlaid onto an image data stream; and

FIG. 5B illustrates tracking functionality with the symbols of FIG. 5A overlaid onto a portion of an image where tracking is being implemented.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

An apparatus which embodies the present invention processes, on a frame by frame basis, real time streaming video from an image generation system. The processed output video is then coupled to the simulation unit, for example a cockpit display system.

In one aspect of the invention, digitized frame-based video from the image generation system is processed with one or more, selectable, sensor effects. Sensor effects can be selected from a class which includes a blurring filter, a finite impulse response filter, additive noise, variable gain and bias on a per pixel basis, AC coupling between the sensor and the respective subsequent amplifiers, nonlinear gain, detail peeking, video gain and bias, data link effects, image inversion, and gamma correction.

The processed video subsequently can be converted to an analog format and forwarded to a cockpit simulator. Additionally, tracking functions and symbol generation can also be incorporated into the image stream.

An apparatus which embodies the invention can incorporate one or more processors and related control software to receive raster scan video, from an image generation system. The video stream can be processed in accordance with selected sensor effects, and can incorporate tracking as well as generate appropriate displayable symbols.

The processed video output can be converted to analog form, in a digital-to-analog converter, and forwarded to the cockpit display for presentation to the user. In another aspect of the invention, first and second processors can be used to carry out the desired processing. One processor can carry out capture and image display functions. The other processor can carry out the image processing functions.

In a disclosed embodiment, the software can be implemented in a multi-task, or multi-thread configuration with one processor executing a thread which is responsible for communications with the image generation system, and a second thread executed on the same processor for carrying out graphics processing, tracking, assembly and generation of histogram and communications with a host processor. Sensor effects processing can be carried out on another thread on the second processor. Those of skill in the art will understand that other configurations, without limitation, come within the spirit and scope of the present invention.

In another aspect of the invention, images are presented frame by frame by the image generating system. An image is acquired in one frame, is processed with sensor effects in a second frame and is displayed in a third frame. Tracking, histogram data collection and reticules can also be implemented in the third frame.

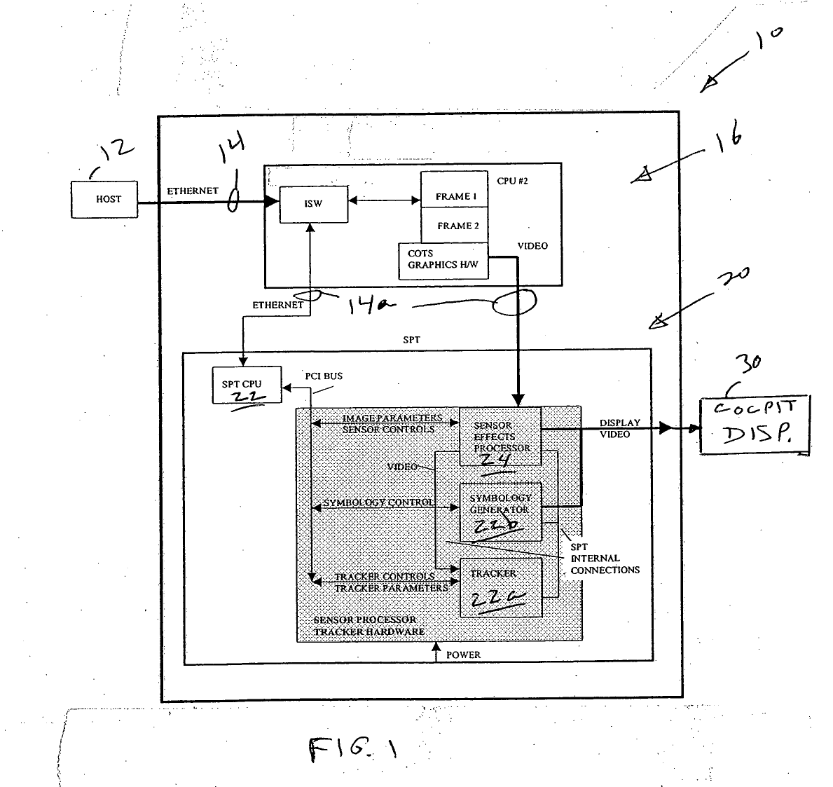

FIG. 1 illustrates a simulation system 10 in accordance with the invention. The system 10 can incorporate a host computer 12 which provides overall control and management of the simulation. The host 12 can communicate via local computer-based communication network, for example an Ethernet connection 14 with a commercially available image generation system 16. It will be understood that the exact nature and characteristics of the image generation system 16 are not limitations of the present invention. Such systems typically output synthesized video, on a frame by frame basis, which can be used to implement the simulation process.

A sensor effects processing system 20 coupled to the image generation system 16 receives images in either analog or digital form as well as command information, via for example an Ethernet connection 14a. As noted, image signals can be received in either analog or digital form from the image generation system 16 without limitation.

The system 20 can incorporate first and second processors 22, 24 and associated control software. Processor 22 can implement one of the threads for communication with the image generation system. A second thread can carry out Ethernet communications as needed, implement tracking as well as reticule functionality and histogram generation.

The second processor 24 implements the third thread and carries out sensor effect processing. Display video which incorporates the results of the sensor effects processing, the tracking functionality and overlaid reticules can be coupled to a cockpit display 30 in any appropriate format. The format can be either a digital or analog without limitation.

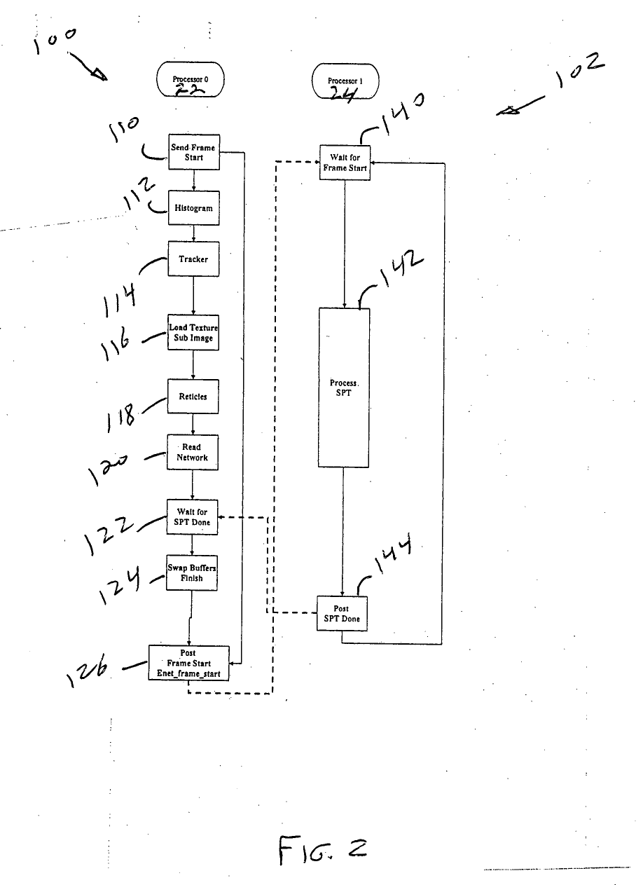

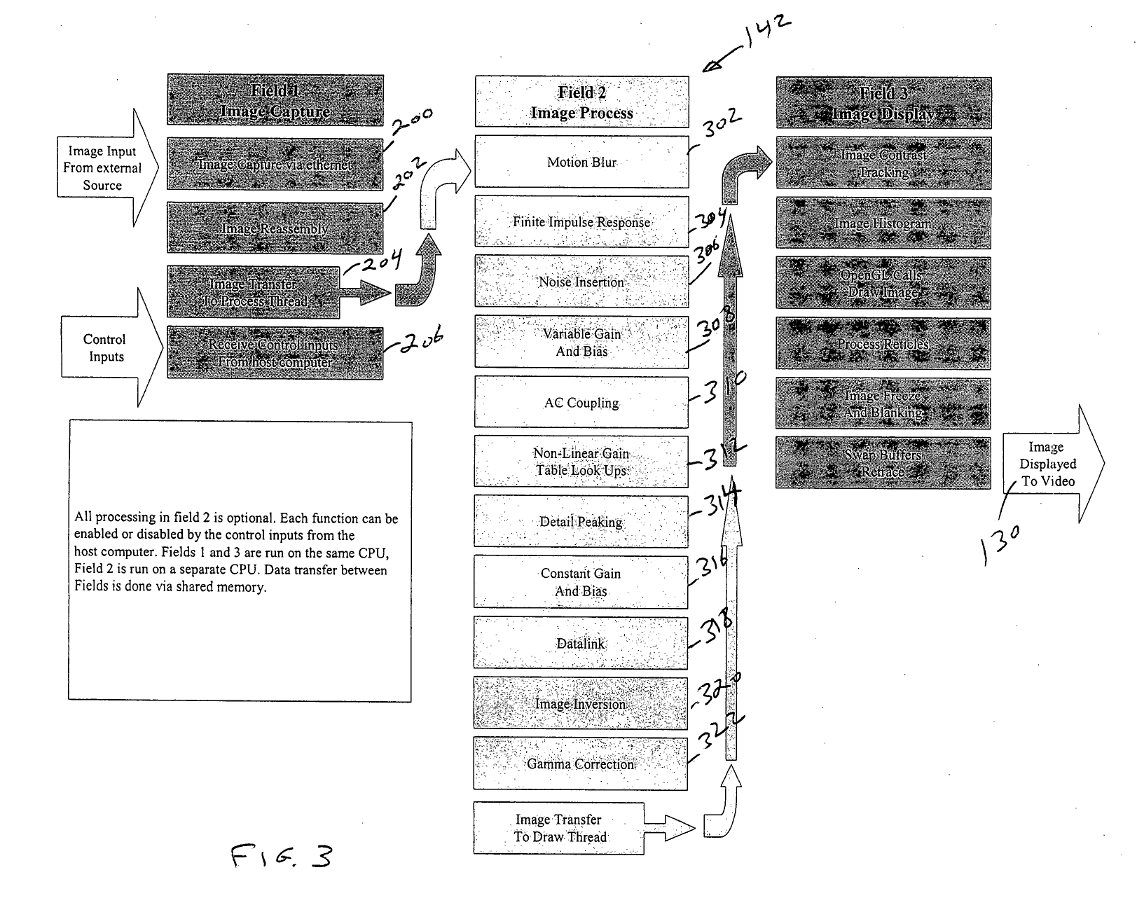

FIG. 2 illustrates aspects of processing 100 at processor 22 and processing 102 at processor 24. Processor 22 executes, in a preferred embodiment, one thread which handles all communications with the image generation system 16. Communications preferably will be carried out frame by frame, on a digital basis, over the Ethernet connection. It will be understood that the exact details of the Ethernet communication process are not limitations of the present invention. Alternately, the image generation system 16 could output an analog signal which could then be digitized by the system 20 and processed accordingly.

Processor 22 also executes a second software thread 100 which carries out graphics processing, tracker processing, histogram processing and other internet communications. Processor 24 executes a third software thread 102 to carry out all sensor effects processing on the received image signals, for example frame by frame video.

With respect to FIG. 2, processor 22 initially sends a frame start code 110 which also triggers processing 102, step 140. In step 112, histogram processing is carried out. In step 114, target tracking processing is carried out. In step 116 subimage information is loaded.

In step 118 reticules, optical instrumentation for the cockpit, display such as crosshairs, tic marks and gauges, is carried out. In step 120 network commands are processed. Subsequently, step 122, processor 22 awaits for sensor effects processing step 142 to be completed. In step 124 buffers are swapped. In step 126 post frame processing is completed.

As noted above, all sensor effects processing takes place, step 142 in processor 24. Subsequently, in step 144 a notification is provided to processor 22 that the sensor effects processing has been completed on the present frame.

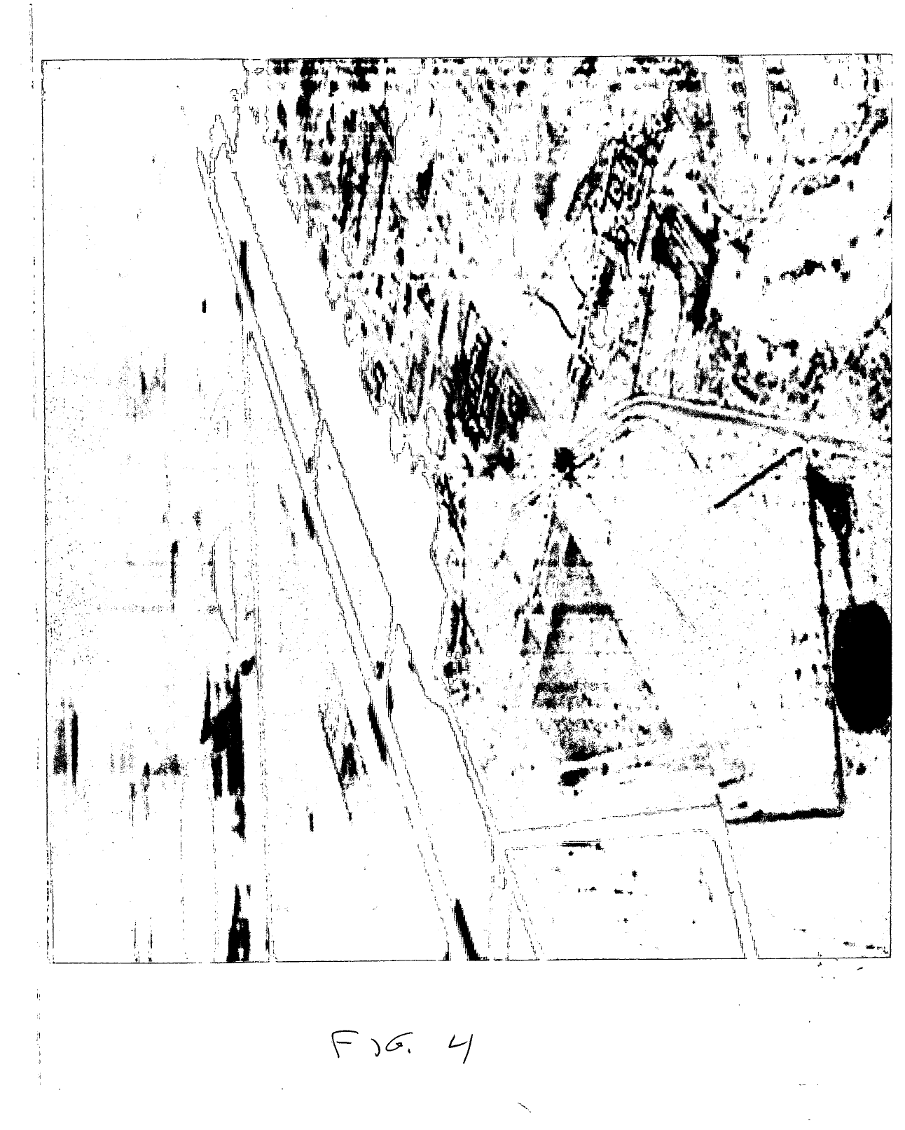

FIG. 3 is a flow diagram of various aspects of processing 100, 102 of FIG. 2. With respect to FIG. 3, fields 1 and 3 are executed by processor 22. Field 2 corresponding to sensor effects processing and illustrated in an overall step 142 is carried out by processor 24.

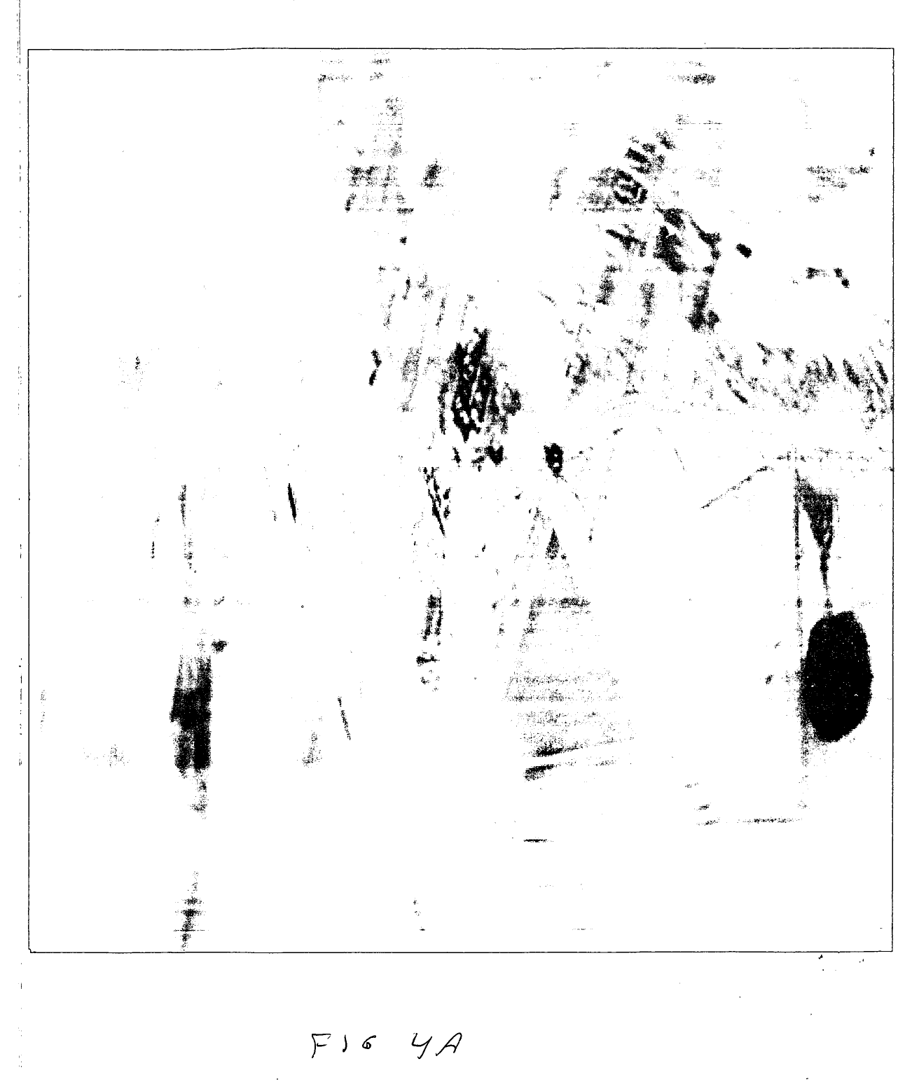

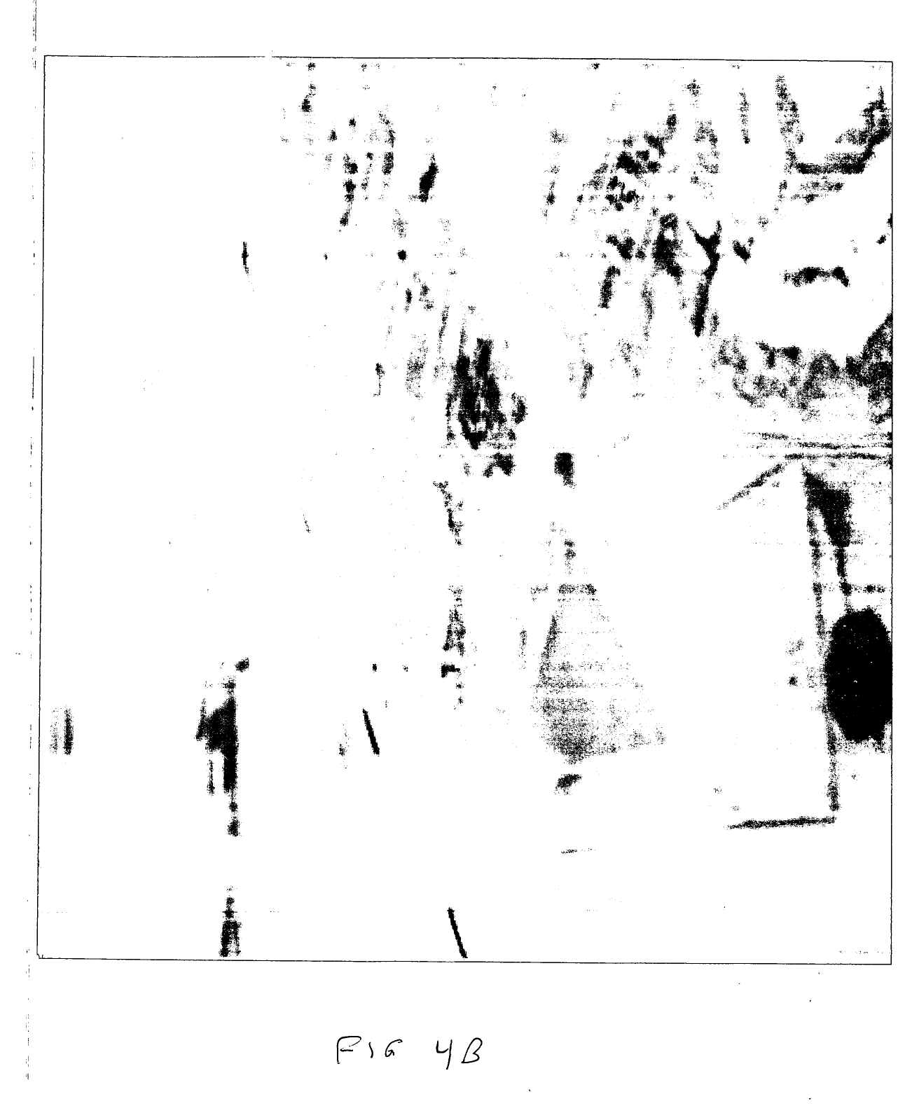

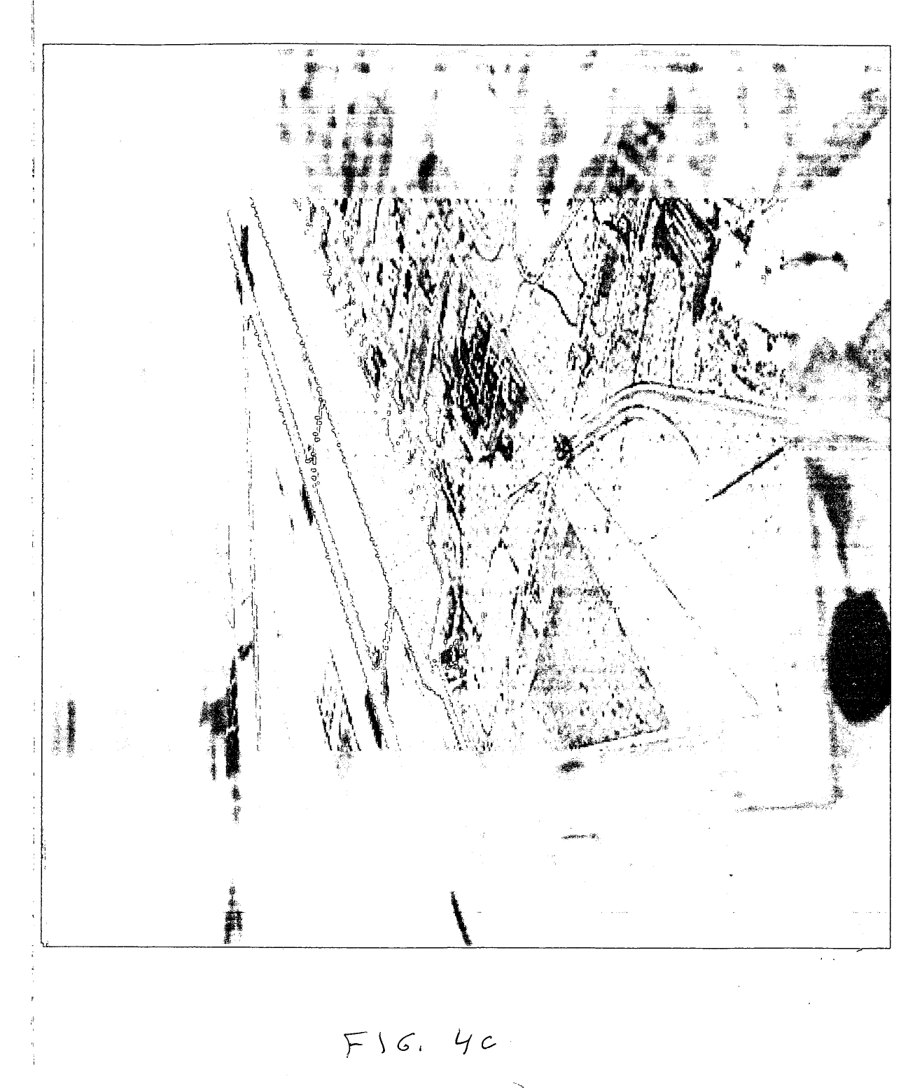

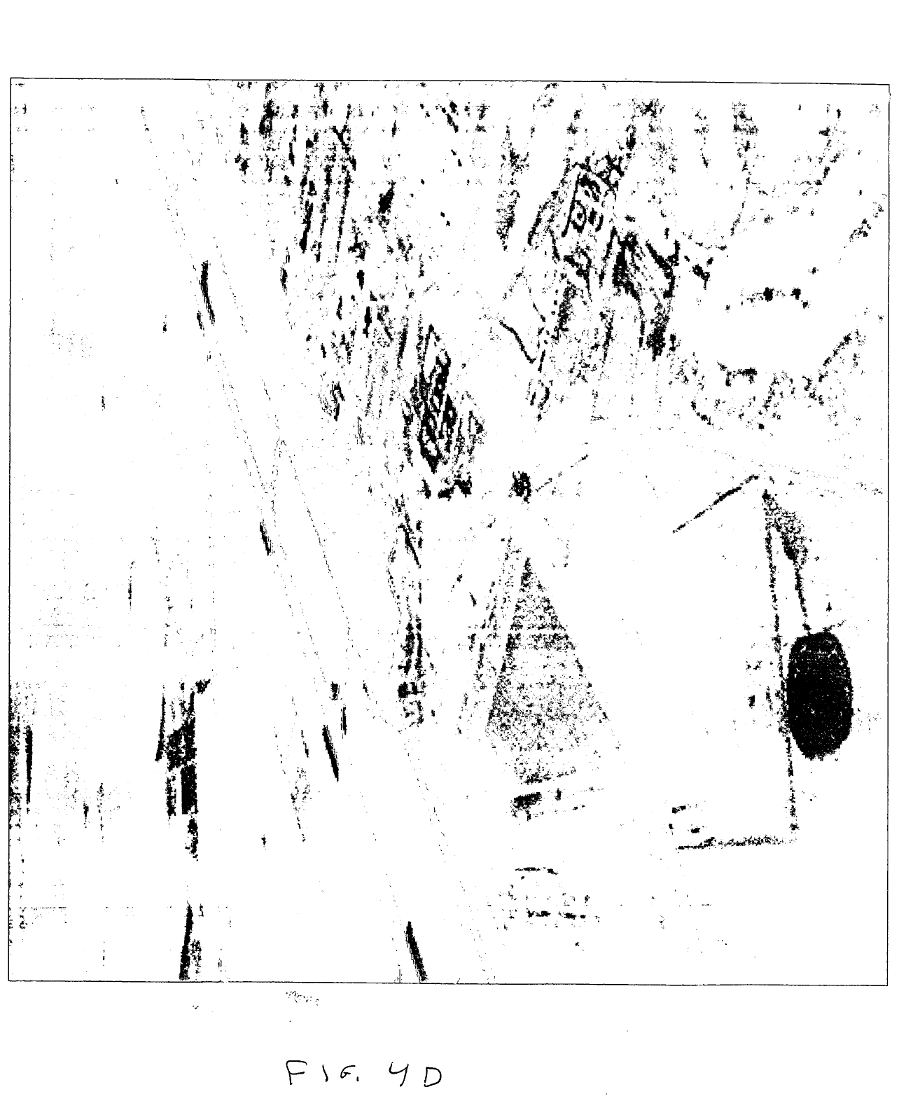

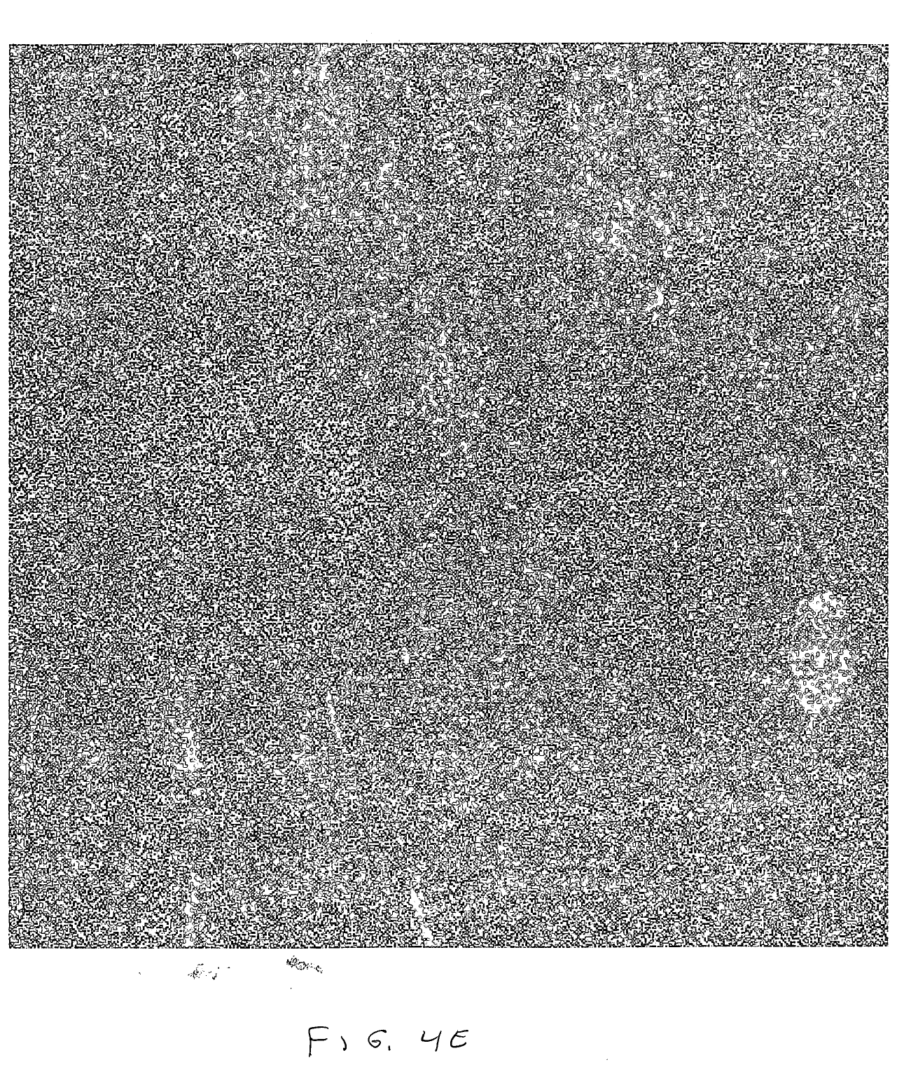

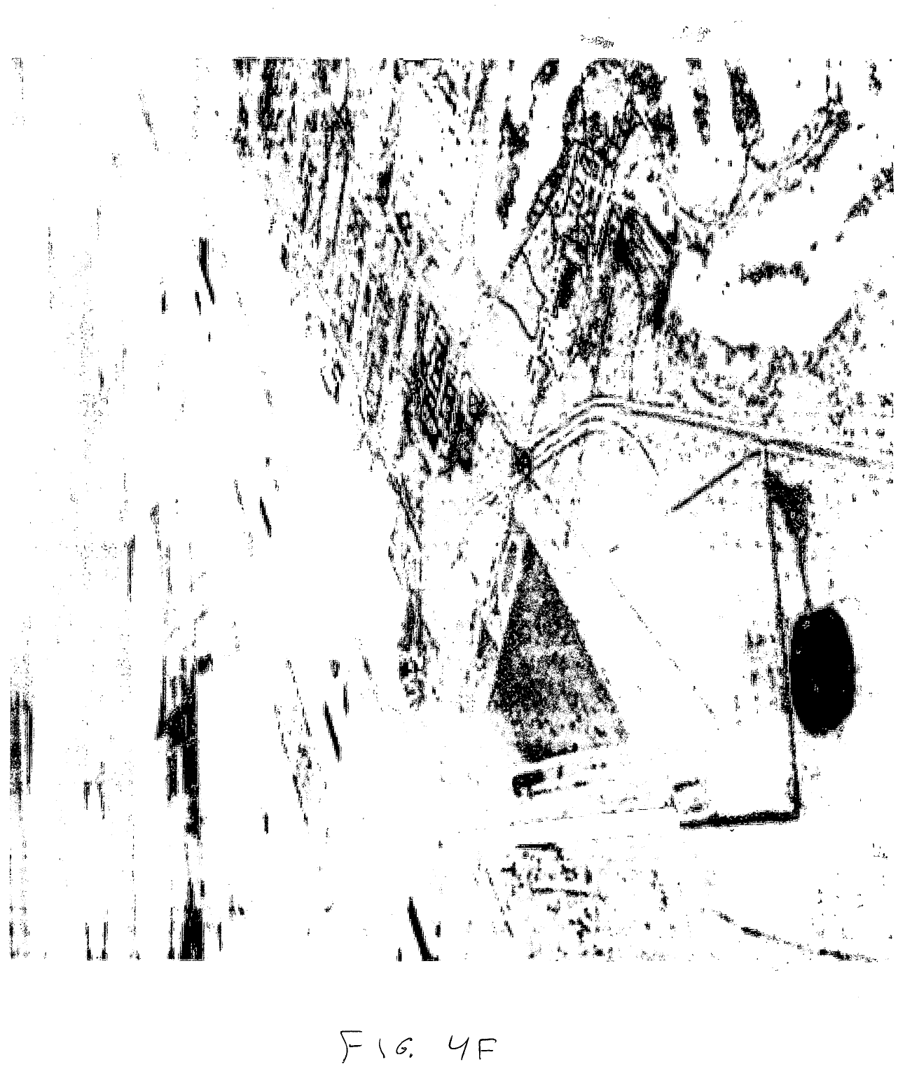

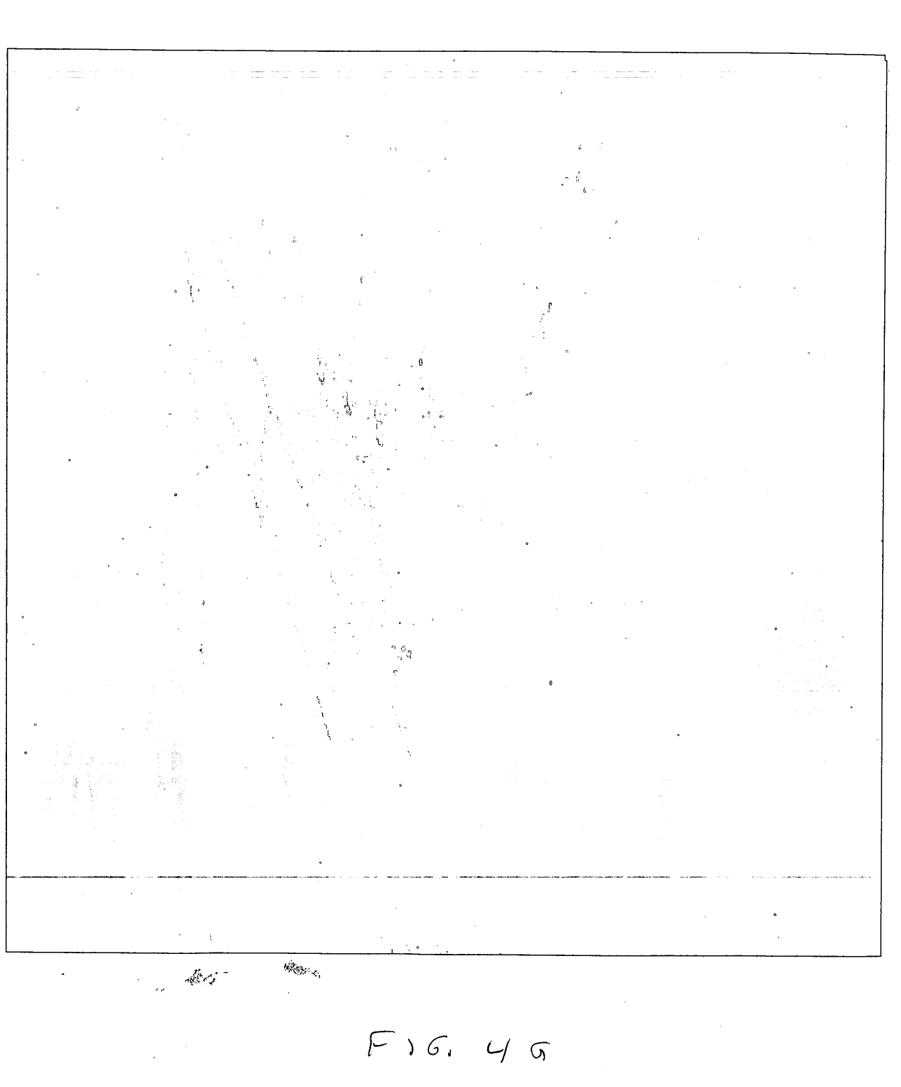

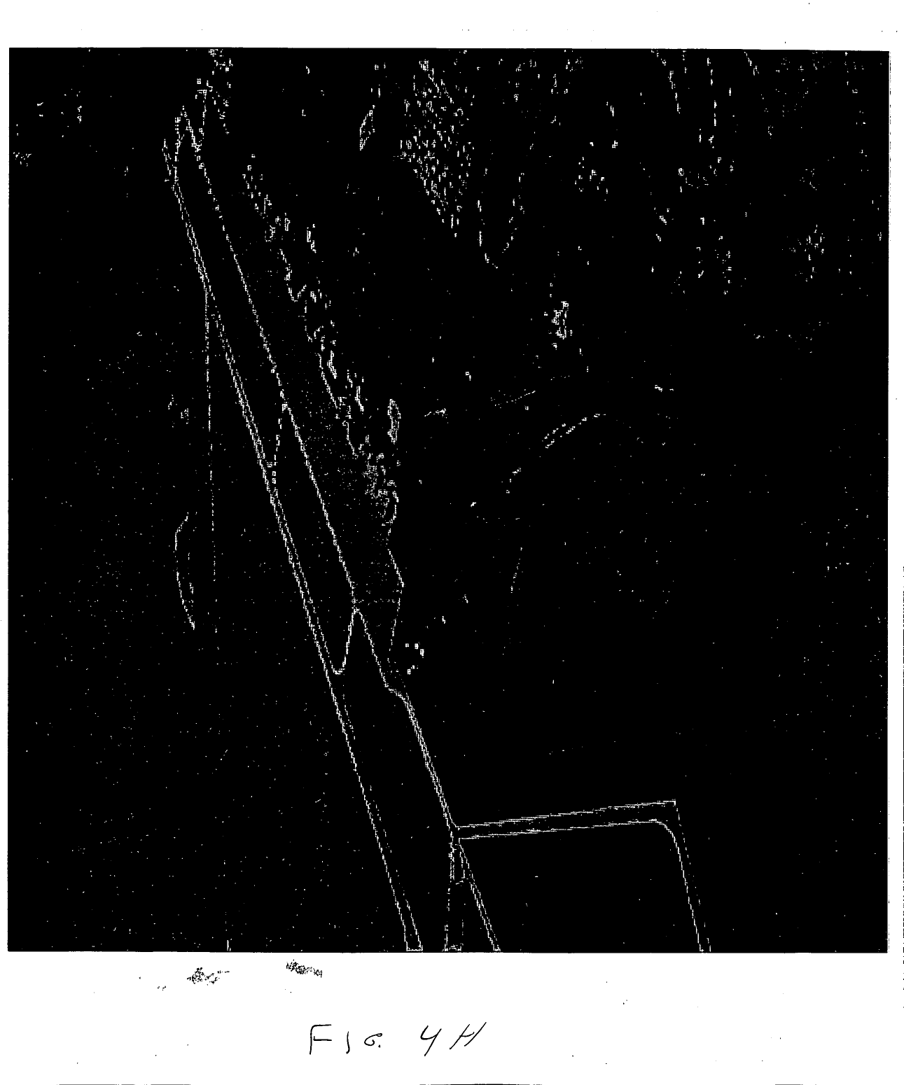

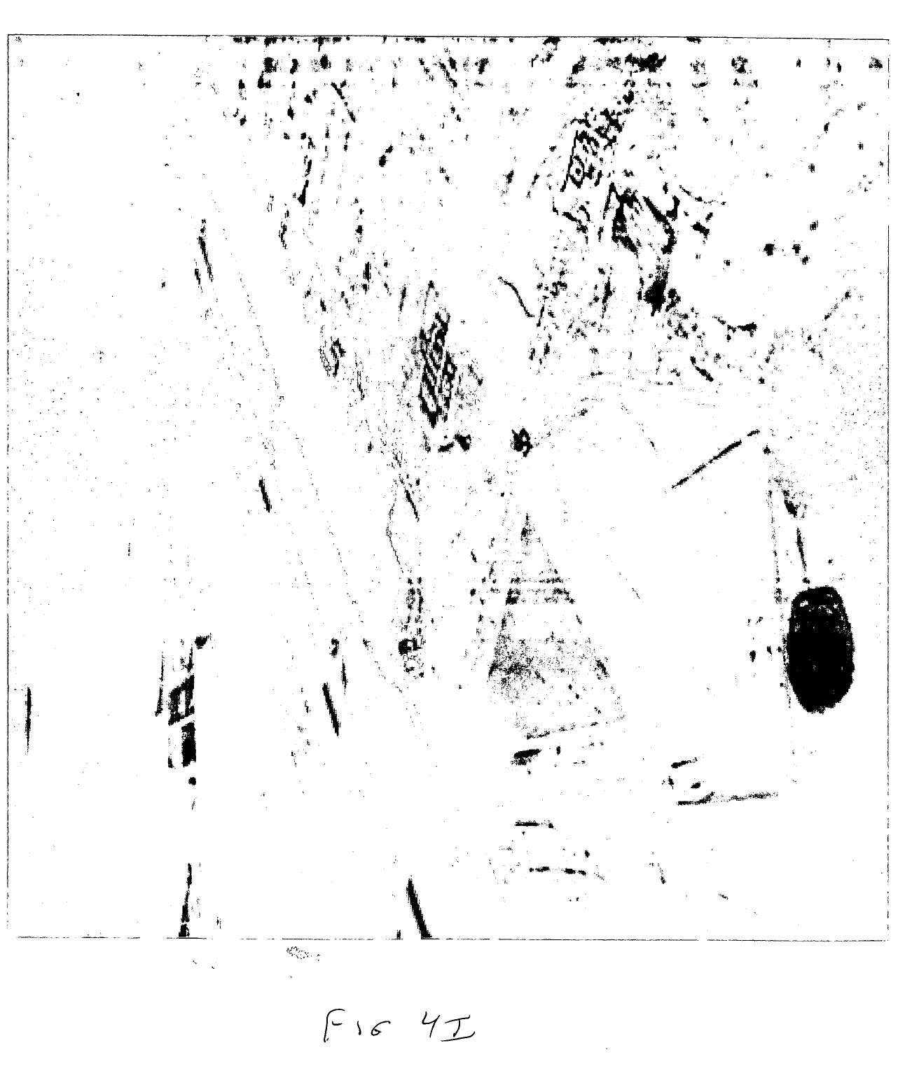

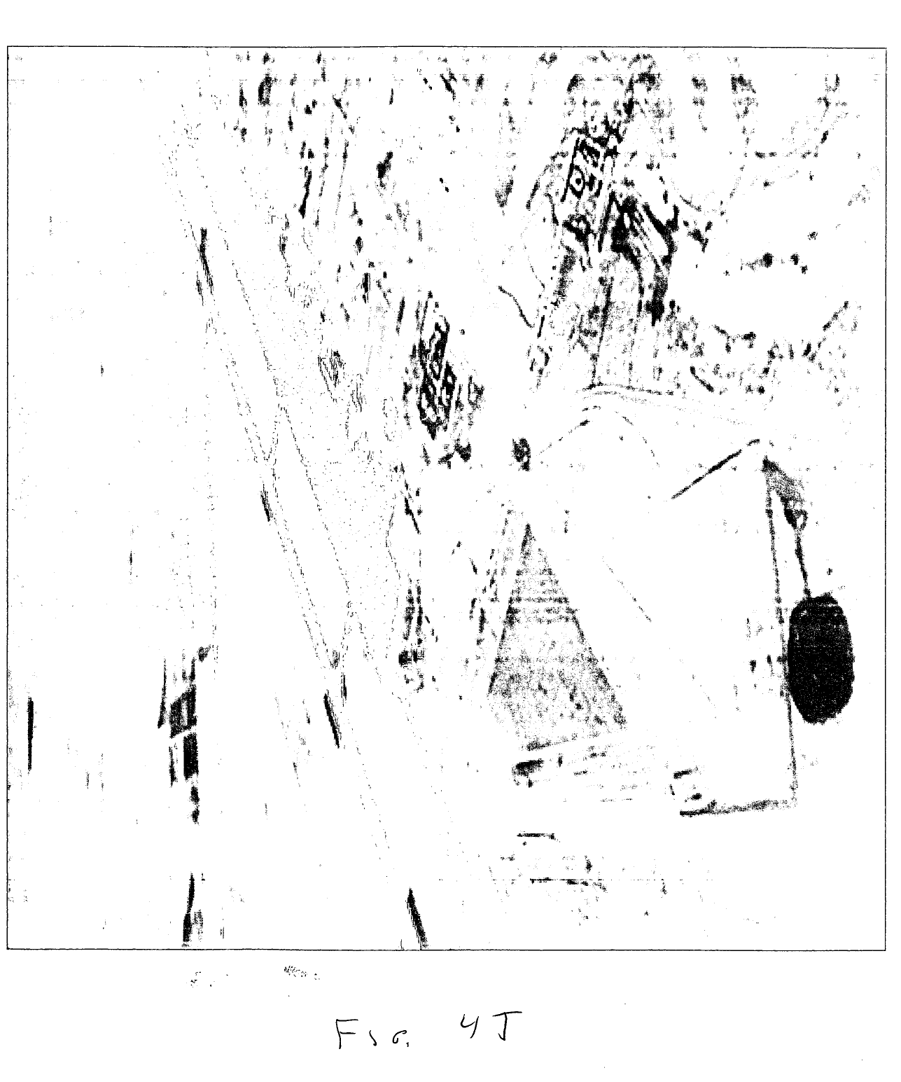

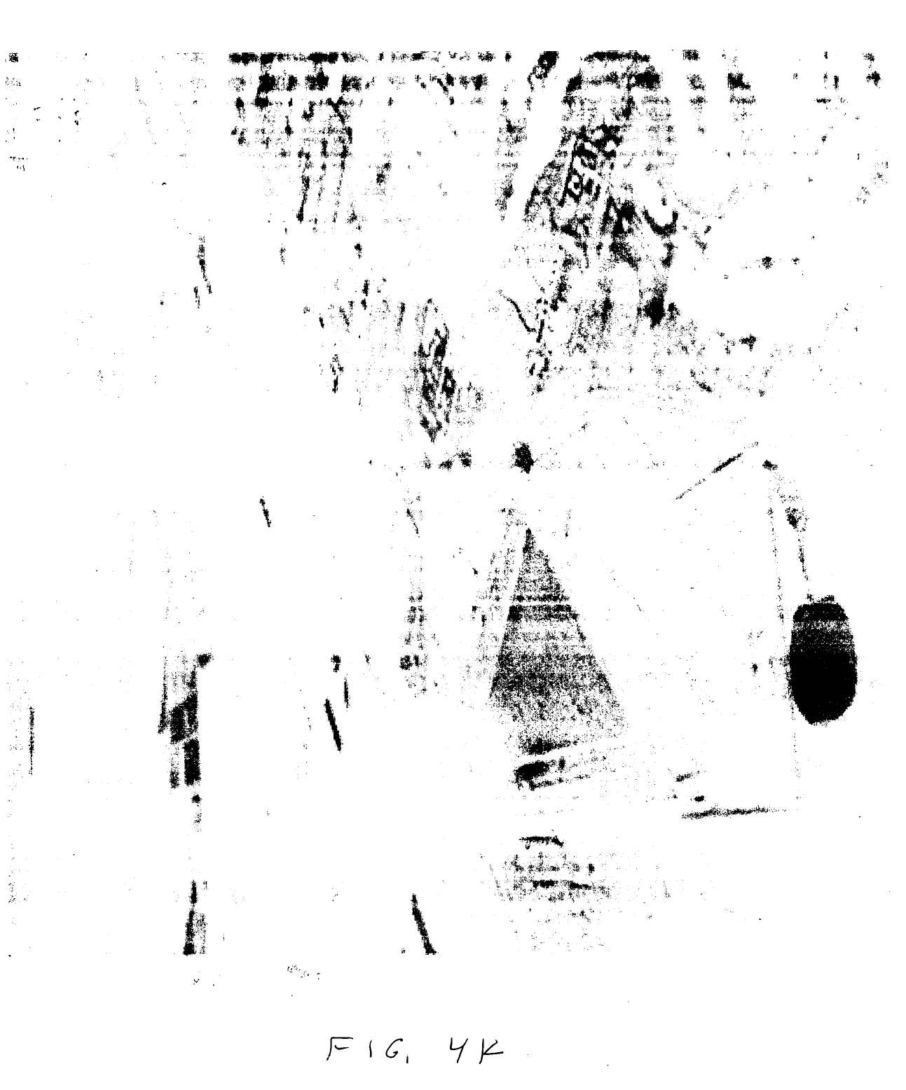

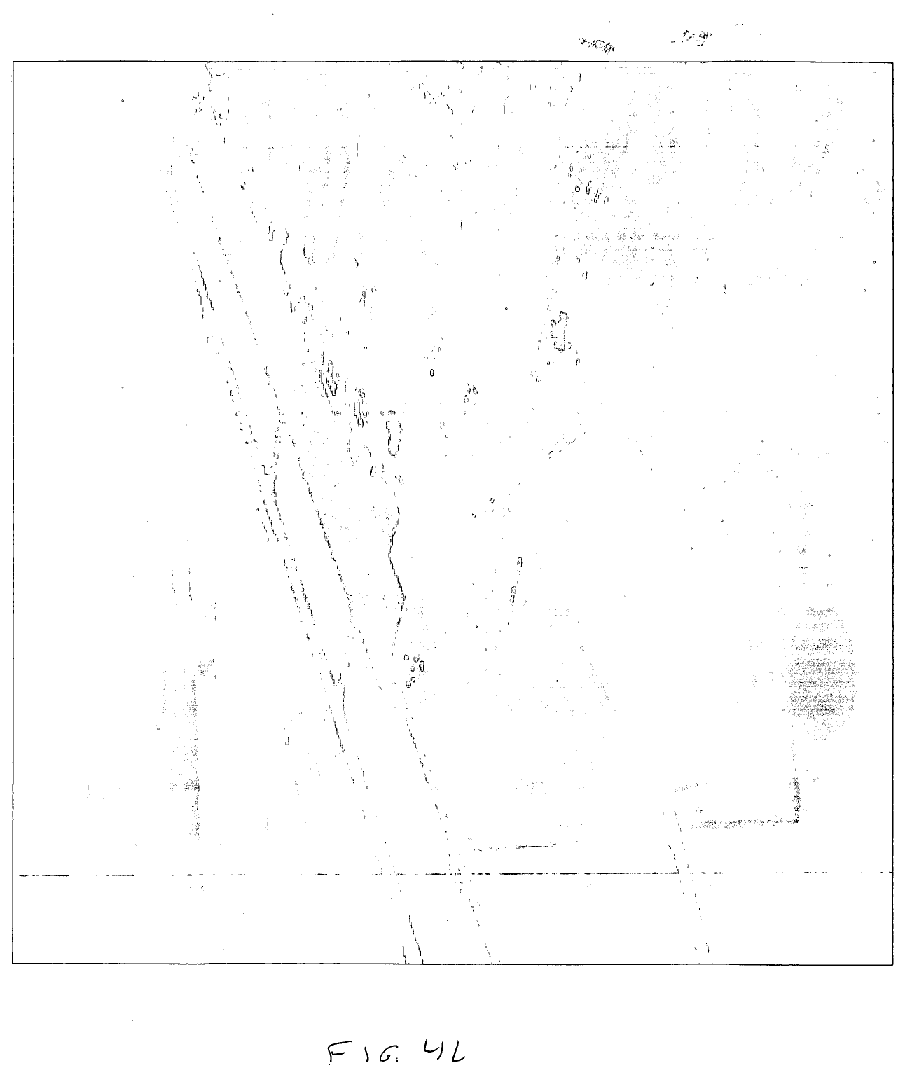

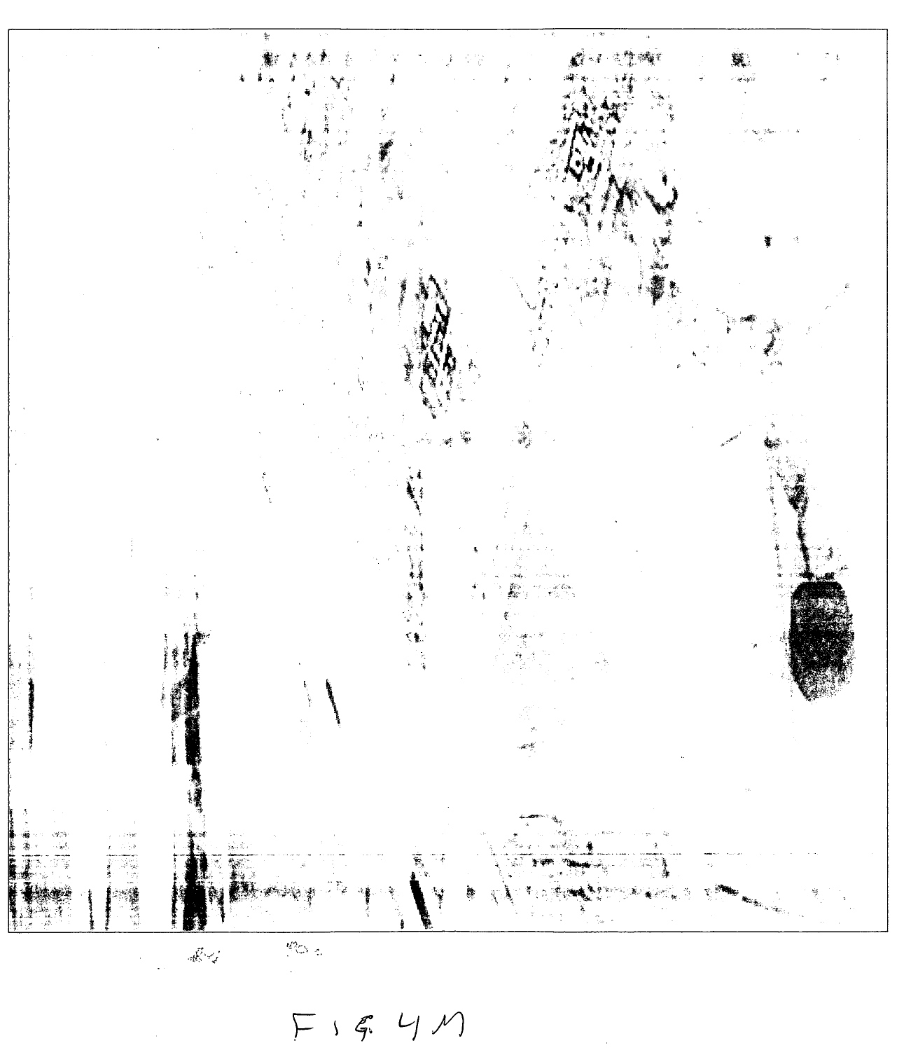

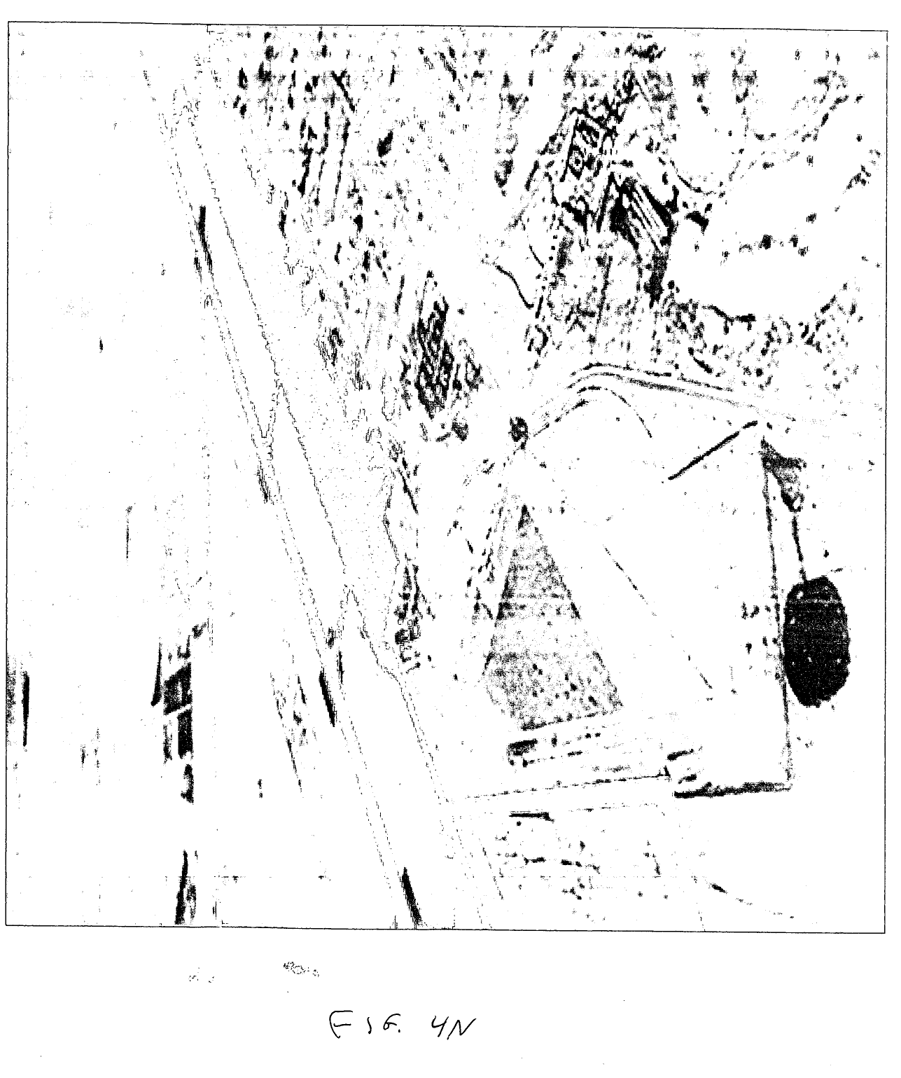

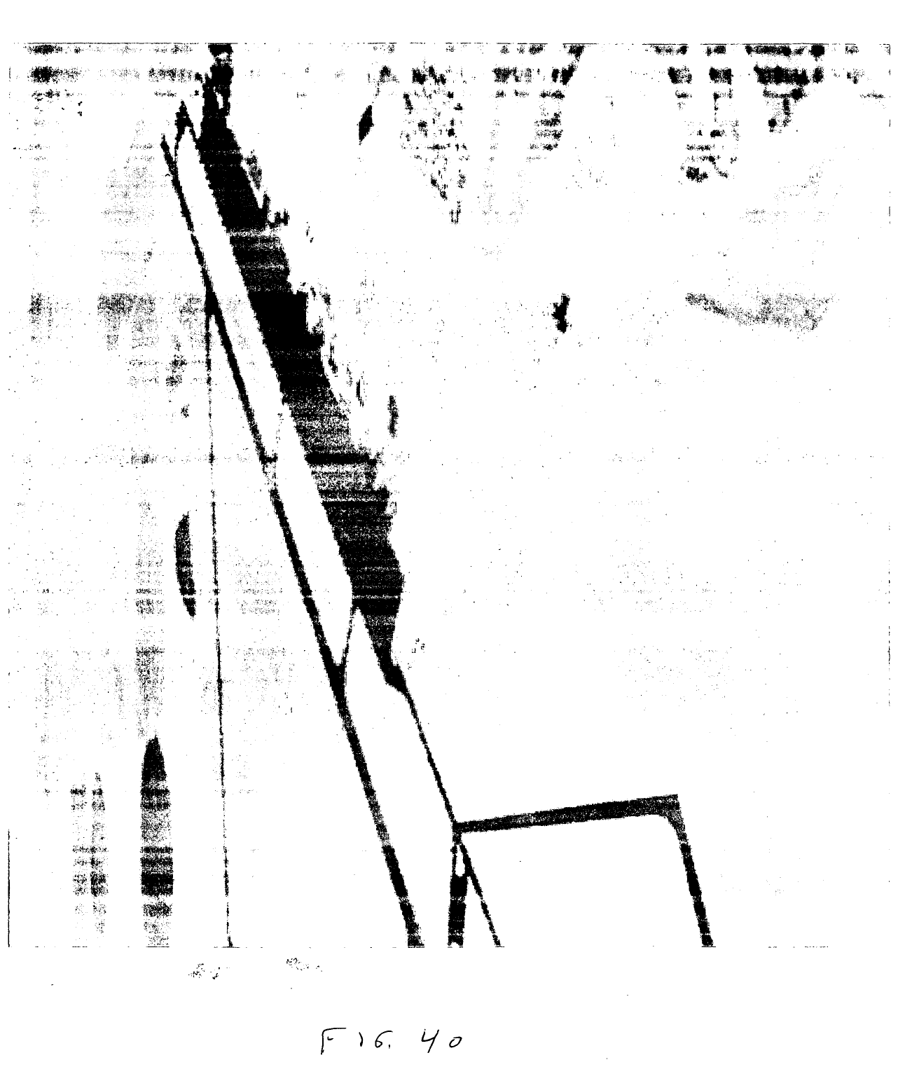

As noted above, images are received on a frame by frame basis in digital form via the Ethernet coupling 14a from the image generation system 16, indicated at step 200. Image reassembly processing as needed is carried out in step 202. The image is transferred step 204 for processing, thread 102. In step 206 the processor 22 receives and processes control inputs from host computer 12. Field 2 image processing operates under the control of a simulation manager who, via host 12, can enable or disable some or all of the functions depending on the desired effects to be presented at the cockpit display 30. Each of the effects is discussed subsequently and an associated figure or figures illustrates the results thereof relative to a common image illustrated in FIG. 4.

If activated, in step 302 motion blur effects are added to the subject image, as illustrated in FIG. 4A.

Motion Blur is implemented by taking the value of a pixel at a previous frame, multiplying it by a constant, and adding it to the value of the pixel in the current frame, multiplied by another constant.
Vout=Vn(i,j)*C1+Vn−1 (i,j)*C2.
Typically C1+C2=1 to avoid increasing the brightness of the image, however this constraint need not be enforced.

The output of the motion blur processing, step 302 is coupled to a finite impulse response (FIR) filter, step 304 if activated. FIG. 4B illustrates the results relative to the background of the image. FIG. 4C illustrates the results of such processing relative to an inset area or a defined mask. The simulation manager can define the characteristics of the finite impulse response filters.

The FIR filter includes two separate filters, on an inset area and the rest of the image, as defined by user inputs. The filters use seven horizontal and seven vertical coefficients in both the inset and the outer area.

Noise insertion can be carried out relative to the image stream, step 306 with varying noise values. Representative examples of the effects of varying noise on a image are illustrated in FIGS. 4D, 4E.

Noise insertion is done by generating a table 4096 by 4096 of random numbers between 0 and 1. Each field, a random pointer into the table is generated, and the values are read starting at the pointer and incrementing once for each additional pixel. The noise value is multiplied by a noise gain factor, and then added to the intensity of the pixel.

Per pixel gain and bias can be injected into the image stream, step 308. The effects of various gains are illustrated in FIGS. 4F, 4G.

Per pixel gain and bias is implemented by generating an offline table, of the same size as the output image. Each pixel's unique gain and bias value is looked up from this table each field, and the pixel's intensity is multiplied by the gain, and the bias is added in. The value is then clamped to the maximum value for output intensity.

AC coupling can be simulated relative to the image stream, step 310. The results of such simulated AC coupling are illustrated in FIG. 4H.

AC coupling is simulated by summing the intensities of the entire line of the previous field's image, and dividing that by the number of elements in a line. This gives us the average intensity of a pixel in the line the previous frame. This average intensity is then subtracted from each pixel in the current line of the current field being processed.

The image data stream can be altered by imparting non-linear gain thereto, step 312. The results of imparting the nonlinear gain are illustrated in FIG. 4I.

Non-Linear Gain is implemented by using the intensity a given pixel as an index into a table, which provides the output intensity. These tables are generated offline to simulate the appropriate non linear gain function to be implemented.

Detail peek processing can also be applied to the elements of the data stream, step 314. The results of such processing are illustrated in FIG. 4J.

Detail peeking can be accomplished by using 7 horizontal coefficients. The three pixels before and after the current pixel being processed are multiplied by their respective coefficient, and summed into the intensity of the current pixel multiplied by its coefficient to produce the final intensity.
V(i,j)out=C0* V(i−3,j)+C1*V(i−2,j)+C2*V(i−31j)+C3* V(i,j)+C4*V(i+1,j)+C5*V(i+2,j)+C6*V(i+3,j)

The presence of constant gain and bias can be simulated, step 316. The results thereof are illustrated in FIGS. 4K, L for different bias values.

Constant gain and bias is simulated by passing in a gain and bias value for the scene. The pixel's intensity is multiplied by the gain, and the bias is added in. The value is then clamped to the maximum value for output intensity.

Ghosting can be simulated, step 318. FIG. 4M illustrates the optical effects of imparting ghosting to the data stream.

Datalink effects, or ghosting, is simulated by passing in three constants (C1, C2 and C3), and two offsets (p1 and p2) for the ghosted images in pixels. The intensity of a given pixel is multiplied by the constant C1. The intensity of a pixel p1 elements and p2 elements ahead in the line are multiplied by C2 and C3 respectively an added in to determine the output pixels intensity as follows:
Vout=V(i,j)* C1+V(i,j+p1)*C2+V(i,j+p2)*C3

Image inversion processing can be implemented in step 320 if activated. FIG. 4N illustrates the effects of presenting hot surfaces in white. Additionally, FIG. 40 illustrates presenting hot surfaces in black.

Image Inversion is implemented by taking the intensity of a given pixel and subtracting it from the maximum intensity a pixel can have.

Gamma correction as would be understood by those of skill in the art can also be implemented, step 322. Subsequently, once the processor 22 receives an indication that the processing 142 has been completed the steps of thread 100 illustrated in Field 3 of FIG. 3 are completed. The image to be displayed is then forwarded to the cockpit display 30 in an appropriate format, step 130.

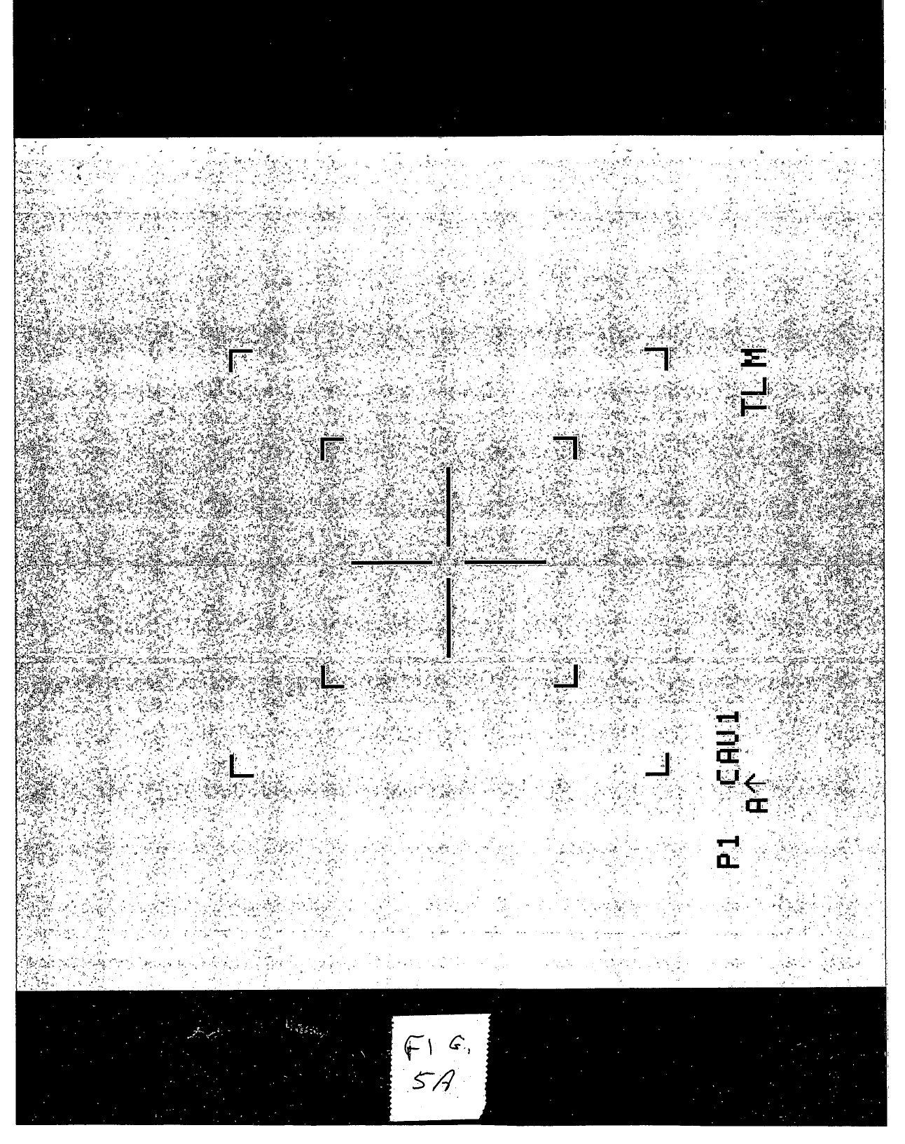

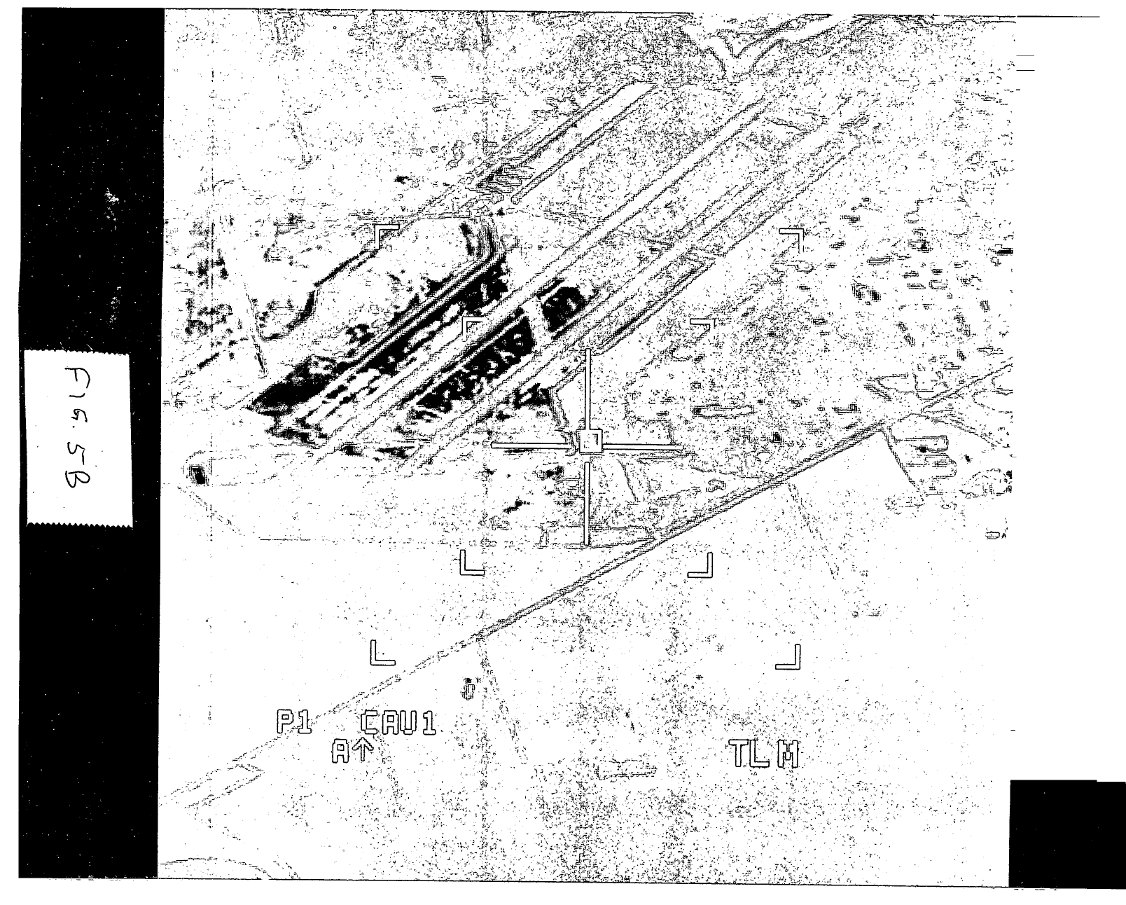

FIG. 5A illustrates symbols of a type which can be overlaid onto the data stream by the system 20. FIG. 5B illustrates tracker functionality, step 114 as overlaid onto an image which has been processed with some or all of the above-described sensor effects.

Those of skill will understand that the system 20 can be implemented with a variety of configurations without departing from the spirit and scope of the present invention. Preferably all such configurations will enable the simulation manager, via host 12 to selectively activate those sensor effects which are to be imparted to the simulated vehicle such as a cockpit display 30.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A simulation system comprising:
an image generator;
at least one processor which receives an image related output stream from the generator; and
sensor effects simulation software executed by the at least one processor, the software introduces at least one selected sensory effect into the output stream thereby producing a modified output stream.

2. A system as in claim 1 which includes a vehicle simulator with a plurality of vehicular specific output displays, where the modified output stream provides inputs for the displays.

3. A system as in claim 1 where the software introduces a plurality of selected sensory effects into the output stream thereby producing a modified output stream.

4. A system as in claim 3 where the output stream comprises a plurality of digitized video frames.

5. A system as in claim 4 where the sensor effects are selected from a class which includes at least motion blurring, finite impulse response processing, noise insertion, gain and bias effects, AC coupling, non-linear gain effects, detail peeking, ghosting, image inversion and gamma correction.

6. A system as in claim 5 which includes an aircraft cockpit simulator coupled to the modified output stream.

7. A system as in claim 5 which includes software, executable by a processor, which enables an operator to select at least one member of the class for inclusion in the output stream.

8. A system as in claim 5 which includes a second processor, the second processor acquires the image related output stream from the generator and forwards it to the at least one processor.

9. A system as in claim 8 where the two processors have a shared storage region.

10. A system as in claim 8 where one of the processors executes tracking software.

11. A system as in claim 8 where one of the processors executes software that produces vehicular condition displays.

12. A modular sensor effects simulator comprising:
a port for receipt of streaming image data; and
a first processor, coupled to the port, and software executed by the processor to impart selected sensor effects to the image data substantially in real-time to form a processed image output stream.

13. A simulator as in claim 12 which includes a second processor which executes image data acquisition software and which stores received image data sequentially.

14. A simulator as in claim 13 where the received image data is stored in a region accessible to both processors.

15. A simulator as in claim 12 where image data is acquired on frame-by-frame basis with acquired frames sequentially stored in a selected memory unit.

16. A simulator as in claim 15 which includes circuitry to assemble acquired image data into a respective frame.

17. A simulator as in claim 16 where the circuitry includes a multi-tasking processor which executes frame assembly software and where the two processors can both access the memory unit.

18. A simulator as in claim 17 where the multi-tasking processor executes one task to assemble the image frames and a separate task to implement a target tracking function.

19. A simulator as in claim 17 where the sensor effects are selected from a class which includes at least motion blurring, finite impulse response processing, noise insertion, gain and bias effects, AC coupling, non-linear gain effects, detail peeking, ghosting, image inversion and gamma correction.

20. A method comprising:
generating images on a frame-by-frame basis; and
multi-task processing of the frames sequentially by acquiring a frame during a first frame time, imparting sensor effects thereto during a second time frame and overlaying tracking indicia during a third time frame.

21. A method as in claim 20 which includes storing frames for common access by multiple executing software tasks.

22. A method as in claim 21 which includes coupling processed frames sequentially to a vehicular simulator.
